(19) United States
(12) Patent Application Publication
(10) Pub. No.: US 2013/0069279 A1
(43) Pub. Date: Mar. 21, 2013

(54) Method for producing annular moldings subjected to tensile or pressure loading from plastic

(71) Applicants: Dieter Busch, Pattensen (DE); Mark Frister, Hannover (DE)

(72) Inventors: Dieter Busch, Pattensen (DE); Mark Frister, Hannover (DE)

(73) Assignee: SENSUS SPECTRUM LLC, Raleigh, NC (US)

(21) Appl. No.: 13/640,441

(22) PCT Filed: Apr. 8, 2011
(86) PCT No.: PCT/EP2011/001767

§ 371 Date: Dec. 3, 2012

(30) Foreign Application Priority Data
Apr. 10, 2010 (DE) 102010014487.8
Apr. 10, 2010 (DE) 202010004839.7

(51) Int. Cl. B29C 45/00

(52) U.S. Cl. CPC B29C 45/0046
USPC 264/319; 425/559

(57) ABSTRACT

The invention relates to methods for producing annular moldings subjected to tensile or pressure loading from plastic by using an injection mold having a main cavity, at least one extra cavity is incorporated in the injection mold. The at least one extra cavity is joined to the main cavity by a connecting duct. The main cavity is filled with plastic melt so a flow line is formed in the vicinity of the connecting duct between the at least one extra cavity and the main cavity, wherein the cross section of the connecting duct is dimensioned such that, during the filling of the main cavity, no plastic melt flows into the extra cavity. The filling pressure is increased until plastic melt flows into the extra cavity; flow taking place through the flow line produced during the filling of the main cavity. Subsequently, the injection mold is opened and the molding removed.

### TECHNICAL FIELD

The invention relates to a method for producing annular moldings subjected to tensile or pressure loading, said molding being made from plastic according to the preamble of the claim 1, and to a valve for pressurized fluids according to the preamble of the claim 8.

### PRIOR ART

The documents DE 10 2005 042 579 A1, DE 37 32 703 A1 and DE 37 40 531 A1 show compound water meters, the housings of which have an upper opening through which measurement fixtures can be inserted and removed. The pressure-tight closure of the upper opening is implemented through a pressure cover which is detachably connected to the housing by means of fastening screws. For the purpose of compressive strength, the pressure cover is made from metal. The measuring element is placed on the pressure cover. If the pressure cover is amagnetic, e.g., made from brass, the rotation of the turbine can be transmitted to the meter movement by means of permanent magnets.

For many different reasons, attempts have been made for many years to make valves coming into contact with drinking water no longer from metal, in particular no longer from brass, but to make them from plastic. However, plastics have some properties which require specific adaptation to this use. Firstly, plastics are considerably less stable than metals. Furthermore, plastics tend to yield under the influence of permanent compressive or tensile forces. Furthermore, water diffuses into the plastics and reduces additionally their strength. If due to increased strength requirements, the plastics have to be reinforced with glass fibers or ceramic fibers, this makes the injection molding process more difficult.

Finally, it was found that the way in which the plastic melt injected into the injection mold is distributed therein and at which place the so-called flow lines are positioned is essential for the strength of the finished molding. Injection moldings with disadvantageously positioned flow lines show considerably reduced strength values. This is unsatisfactory.

Flow lines are created when cooled flow fronts of the plastic injected into the mold meet each other and therefore cannot bond sufficiently. When the plastic melt flows during the filling process, for example, around a core, the melt cools down at the core surface, resulting in a weakening of the flow line.

A number of methods are known in the art so as to improve the quality of the flow line.

The first method is based on the concept of specifically heating the flow front. Thus, e.g., a core around which the plastic melt flows can be heated to reduce or avoid the cooling of the melt. Furthermore, it is known to temporarily heat the tool surface in the region of the flow line at the time of filling. This makes the melt front softer and a better intermixing of the material in the region of the flow front is achieved. However, this can result in an increased cycle time.

In the case of moldings which are injected through a plurality of sprues at the same time, flow lines cannot be avoided because the different melt flows meet each other at the end of the flow path. By using the so-called cascade injection molding, the cavity is filled at the beginning of the filling phase only through one sprue nozzle. If the melt front flows over the next section, the next nozzle is opened, and new melt is injected into the existing melt flow. In this manner, large flow paths can be bridged in a plurality of nozzles without cold flow fronts encountering each other. However, this requires costly controlling of the sprue nozzles, and the cycle is increased.

An improvement of cascade injection molding can be achieved by using suitably controlled hot runner nozzles. For this, the cavity is initially filled through all nozzles. Shortly before filling is completed or during a holding pressure phase, the remaining cavity is filled only through one nozzle. As a result of this, a flow takes place through the flow line region between the nozzles. Here too, costly controlling of the sprue nozzles is required.

Another known possibility of improving the quality of the flow line of a molding is the so-called push-pull injection molding. Here, the cavity is filled through two injection units which can be actuated independently of each other. After the filling by both units, the screw of the one unit is pulled through while the other unit continues to inject. Thereby, the still liquid core of the flow line is shifted. Since for this approach a plurality of injection units including an adequate controller is necessary, this method is very costly.

In all cases it is attempted to let a flow run through the flow line so as to improve the mechanical properties of said flow line. Here, the plastic core of the flow line is shifted after the flow fronts meet each other. The flow line which otherwise extends planarly in cross-section thereby becomes parabolic and resembles a tongue-and-groove joint. The best and also most costly way to achieve this is to use the above-described methods of cascade injection molding and push-pull injection molding which are very costly, however.

### SUMMARY OF THE INVENTION

It is an object of the present invention to provide a method for producing moldings using an injection mold having a main cavity in which the molding is molded, and at least one core.

This object is achieved by a method with the features of the patent claim 1.

The present invention is based on the idea to enable a flow passing through the flow line in that an extra cavity into which the plastic melt can flow is provided at particularly critical places, wherein the hot plastic melt flows through the core of the flow lines, thereby generating the aforementioned parabolic shape.

Another advantage of the method according to the invention is that by skillfully positioning the extra cavity, the direction of the fibers of fiber-reinforced plastics can be controlled, e.g., parallel to each other and perpendicular to the direction of force, as a result of which the compressive strength of the plastic molding is significantly increased. In this manner, the properties of homogenous fiber-reinforced plastics are almost achieved.

The resulting extra moldings can subsequently be removed. However, these additional moldings can optionally also perform useful functions for which strength is not important.

A typical field of use of the method according to the invention is that of valves for pressurized moldings for water installations, e.g., housings, pressure covers and clamping rings of water consumption meters. An essential advantage here is that the housing and/or the pressure plate are made of plastic. Plastic is amagnetic so that rotations of the measuring element can be transmitted to the meter movement by means of permanent magnets. Moreover, plastic exerts no disadvantageous influence on the fluid to be measured, in particular water.

For improving the mechanical stability of the molding it has proven to be advantageous to form the flow line laterally offset with respect to the connecting duct. It is in particular of advantage that the flow line is formed in a molding section which is located in a region which is under low mechanical load when the molding is used as intended.

Preferably, a plastic injection point is positioned in the injection mold in such a manner that at least one flow line forms in the vicinity of the connecting duct.

If a plurality of plastic injection points is used, these points are positioned such that the flow lines form in the vicinity of the connecting ducts.

Advantageously, the plurality of injection points is actuated such that the flow lines form next to the connecting ducts during the injection of the plastic, and that the plastic melt flows into the extra cavities during the subsequent pressure increase, wherein a flow passes through the flow lines created during the filling of the main cavity.

It is a further object of the invention to provide a valve for pressurized fluids, in particular water, said valve having a clamping ring, wherein the clamping ring is made of plastic and has a high strength.

This object is achieved by a valve with the features of the claim 8.

Thanks to the specific shape of the clamping ring with the extra moldings connected through studs, highly-loaded plastic moldings without weakening flow lines and with optimal orientation of reinforcement fibers can be produced. The extra moldings and studs produced in this manner can subsequently be removed. However, these additional moldings can optionally also perform useful functions for which strength is not important.

Preferably, the valve comprises a housing with an opening and a pressure cover which unlockably closes the opening with fastening devices, wherein the pressure cover comprises a sealing plate and the clamping ring, wherein the sealing plate has a circumferential edge flange, the sealing plate is injection-molded from plastic, and the clamping ring clamps the sealing plate onto the housing.

According to a preferred embodiment of the invention, the edge flange is chamfered toward the outside, and the clamping ring is shaped so as to fit thereto. This chamfer ensures that the pressure pressing from below against the sealing plate causes tensile stresses in the pressure ring. However, thanks to the plastic melt flowing into the extra moldings, reinforcement fibers contained in the plastic are ideally oriented also in the region where the flow passes through the flow line.

An essential advantage is that the sealing plate is made of plastic. Plastic is amagnetic so that the rotations of the turbine can be transmitted to the measuring element by means of permanent magnets. In addition, plastic exerts no disadvantageous influence on the fluid to be measured, in particular water, if food-safe material is selected.

A typical field of use of the valve according to the invention, with the clamping ring according to the invention, is that of water meters, e.g., compound water meters comprising a housing that has a lateral opening that is to be closed by a pressure cover.

### BRIEF DESCRIPTION OF THE DRAWINGS

The invention shall be explained in more detail in the form of an exemplary embodiment and with reference to the drawing. In the figures, purely schematically:

FIG. 1 shows a first injection mold for producing from plastic an annular molding subjected to tensile or pressure loading,

FIG. 2 shows a second injection mold for producing from plastic an annular molding subjected to tensile or pressure loading,

FIG. 3 shows as a perspective an annular molding subjected to tensile or pressure loading,

FIG. 4 shows a longitudinal section through a turbine meter,

FIG. 5 shows a perspective view of a combination of sealing plate and clamping ring, and

FIG. 6 shows a third injection mold for producing from plastic an annular molding subjected to tensile or pressure loading.

### DETAILED DESCRIPTION OF THE EXEMPLARY EMBODIMENTS

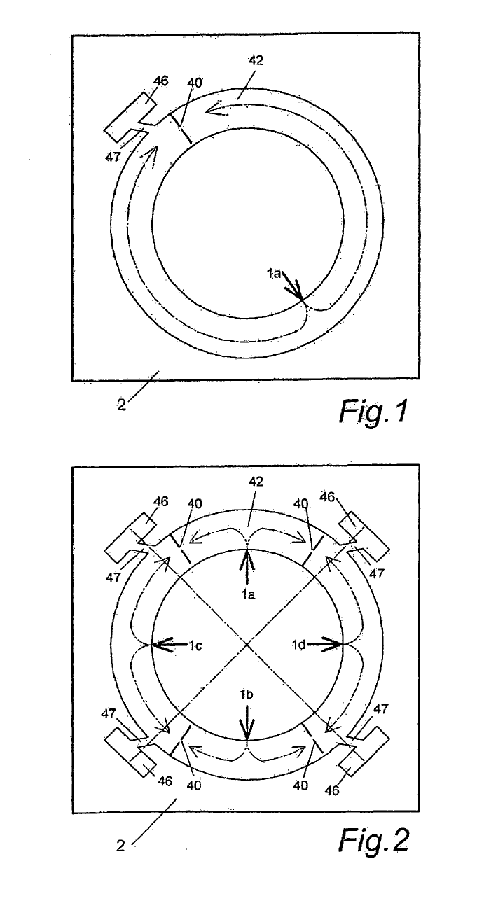

FIG. 1 shows purely schematically a first injection mold 2 having a main cavity 42 for producing from plastic an annular molding subjected to tensile or pressure loading. The plastic melt is injected at an injection point 1a into the main cavity 42 and flows more or less uniformly to the right and the left. Where the two partial flows meet, a flow line 40 is created. Since the fronts of the two partial flows have slightly cooled down in the meantime, there is the risk the flow line 40 has a significantly reduced strength.

In order to avoid this, an extra cavity 46 which is connected to the main cavity 42 via a connecting duct 47 is incorporated in the injection mold 2. The extra cavity 46 is laterally offset with respect to the flow line 40. Cross-section and/or direction of the connecting duct 47 are selected such that initially no plastic melt enters the connecting duct 47. This happens only after the injection pressure is increased, i.e., in the so-called holding pressure phase. While plastic melt enters the extra cavity 46, a flow passes through the flow line 40, and the aforementioned parabola-like flow front forms.

FIG. 2 shows the conditions in the case of a second injection mold 2 with the plastic melt being injected into the main cavity 42 at four injection points 1a, 1b, 1c, 1d. Here, initially, less material is injected through the injection points 1a and 1 than at the injection points 1c and 1d in order to position the flow lines 40 on the desired side next to the connecting ducts 47 to the extra cavities 46. During the holding pressure phase, the injection pressure at the injection points 1a and 1b is increased so that a flow passes through the flow lines 40 while the extra cavities 46 fill up.

In a third injection mold 2 illustrated in FIG. 6, the same amount of material of the plastic melt is injected in each case into the main cavity 42 through the four injection points 1a, 1b, 1c, 1d. The position of the injection points 1a, 1b, 1c, 1d is selected such that the flow lines 40 are located on the desired side next to the connecting ducts 47 to the extra cavities 46. During the holding pressure phase, the injection pressure is increased at all injection points 1a, 1b, 1c, 1d so that a flow passes through the flow lines 40 while the extra cavities 46 fill up.

FIG. 3 shows a clamping ring 12 produced in an injection mold similar to the one in FIG. 2 or FIG. 6. The clamping ring 12 has four fastening openings 14 which are highly loaded by forces. For producing the fastening openings 14, four cores (not illustrated in FIG. 2 or FIG. 6) are required in the main cavity 42. In order to achieve a filling of the main cavity 42 as uniform as possible, the four injection points 1a, 1b, 1c, 1d are provided. The plastic melt injected here flows around the cores on both sides so as to meet on the rear side and to form there the flow lines which cause the known reduction in strength, which, however, is extremely undesirable and is prevented by the four extra cavities 46.

In order to enable the flow through the flow line, the connecting ducts 47 are laterally offset with respect to the flow lines which are created in the filling phase of the main cavity 42 due to the flow around the cores and the converging flow of material of adjacent injection points 1a, 1c; 1c, 1b; 1b, 1d; 1d, 1a.

Through this measure it is achieved that a flow passes through the flow line in the holding pressure phase, when the plastic melt is pushed through the connecting ducts 47 into the extra cavities 46, in such a manner that also in the region of the fastening openings 14, the strength of the finished molding 12 is only insignificantly reduced.

The extra moldings 16 and studs 17 formed in the extra cavities are cut off prior to further use of the molding 12. Alternatively, there is the possibility to give the extra moldings 16 a shape that enables further use, e.g., as a type plate, handle or the like.

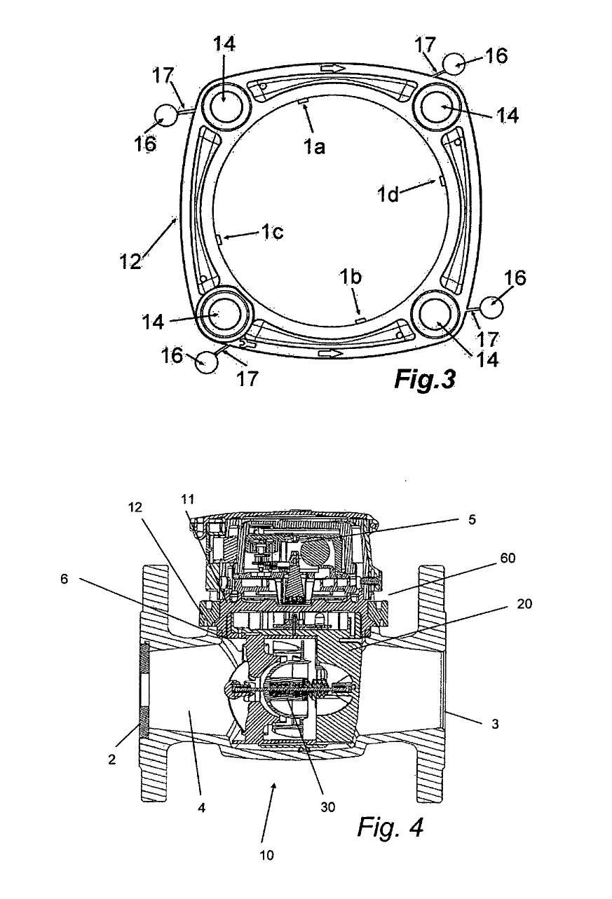

FIG. 4 shows a longitudinal section through a turbine meter. A housing 10 comprising an inlet 2, an outlet 3 and a cylindrical, optionally also conical, flow duct 4 can be seen. On the upper side, the housing 10 has an opening 6 which is detachably closed by a pressure cover 60. A measuring element 5 is shown above the pressure cover 60.

In the flow duct 4 below the pressure cover 60 there is a retaining insert 20 which carries all components required for metering, in particular a turbine 30 which is set in rotation by the fluid flowing therethrough, and the rotations of which are transmitted by means of permanent magnets through the pressure cover 60 to the meter movement 5.

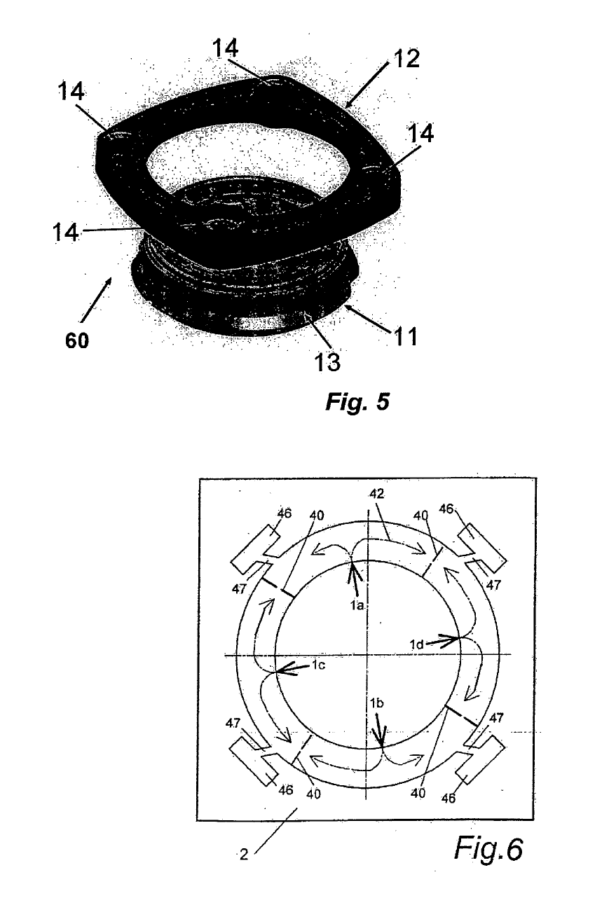

As shown in FIG. 5, the pressure cover 60 is a two-piece design and is injection-molded from plastic. Said cover consists of a sealing plate 11 having a circumferential edge flange 13 and a separate clamping ring 12 with four fastening openings 14. Thanks to the division of the conventional one-piece pressure cover into sealing plate 11 and clamping ring 12, each part can be injection-molded under optimal conditions from plastic.

If the plastic contains reinforcement fibers for improving the compressive strength of the two-piece pressure cover 60, these reinforcement fibers are taken along in the holding pressure phase when the flow passes through the flow lines and are oriented in the direction of the extra cavities. In order to be able to utilize the hereby achieved tensile strength, in particular in the region of the fastening openings, the edge flange 13 of the sealing plate 11 is formed sloping down toward the outside (see FIG. 5). If the interior of the housing 10 is pressurized, the pressure acts from below against the sealing plate 11 which transmits the pressure via the edge flange 13 to the clamping ring 12. In doing so, the chamfer of the edge flange 13 transforms the compressive forces into tensile forces which are optimally absorbed by the reinforcement fibers oriented parallel to each other.

1. A method for producing annular moldings subjected to tensile or pressure loading, said moldings being made from plastic using an injection mold having a main cavity, wherein, in addition to the main cavity, at least one extra cavity is incorporated in the injection mold, wherein the at least one extra cavity is joined to the main cavity by a connecting duct, characterized by the features:
the main cavity is filled with plastic melt in such a manner that in the main cavity in the vicinity of the connecting duct between the at least one extra cavity and the main cavity, a flow line forms laterally offset with respect to said connecting duct, wherein the cross-section of the connecting duct is dimensioned such that during the filling of the main cavity, no plastic melt flows into the extra cavity,
the filling pressure is increased until plastic melt flows into the extra cavity, wherein a flow takes place through the flow line produced during the filling of the main cavity,
the injection mold is opened and the molding is removed.

2. The method according to claim 1, characterized in that the flow line is formed in a molding section which is located in a region which is under low mechanical load when the molding is used as intended.

3. The method according to claim 1, characterized by the feature:
that the flow line forms in the vicinity of the connecting duct by at least one injection point in the injection molding being suitably positioned.

4. The method according to claim 1, characterized by the feature:
that the flow lines form in the vicinity of the connecting ducts by a plurality of injection points in the injection mold being suitably positioned.

5. The method according to claim 1, characterized by the feature:
in the case of a plurality of injection points, the latter are actuated in such a manner that the flow lines form next to the connecting ducts during injecting the plastic melt, and that during the subsequent pressure increase, plastic melt flows into the extra cavities, wherein a flow takes place through the flow line produced during the filling of the main cavity.

6. The method according to claim 1, characterized by the feature:
the extra moldings formed in the extra cavity and the connecting duct are cut off.

7. A valve for pressurized fluids, in particular water, comprising a clamping ring made of plastic and producible according to a method according to claim 1, characterized in that the clamping ring comprises:
openings for fastening devices,
at least one injection point in the vicinity of one of the openings,
and at least one extra molding on that side of the opening that is facing away from the injection point.

8. The valve according to claim 7, characterized by the features:
the valve comprises a housing having an opening
and a pressure cover which detachably closes the opening with fastening devices, wherein
the pressure cover comprises
a sealing plate
and a clamping ring
the sealing plate has a circumferential edge flange,
the sealing plate is injection-molded from plastic,
the clamping ring clamps the sealing plate onto the housing.

9. The valve according to claim 8, characterized by the features:
the edge flange of the sealing plate is chamfered toward the outside,
the clamping ring is shaped so as to fit thereto.

10. The method according to claim 2, characterized by the feature:
that the flow line forms in the vicinity of the connecting duct by at least one injection point in the injection molding being suitably positioned.

11. The method according to claim 2, characterized by the feature:
that the flow lines form in the vicinity of the connecting ducts by a plurality of injection points in the injection mold being suitably positioned.

12. The method according to claim 2, characterized by the feature:
in the case of a plurality of injection points, the latter are actuated in such a manner that the flow lines form next to the connecting ducts during injecting the plastic melt, and that during the subsequent pressure increase, plastic melt flows into the extra cavities, wherein a flow takes place through the flow line produced during the filling of the main cavity.

13. The method according to claim 3, characterized by the feature:
in the case of a plurality of injection points, the latter are actuated in such a manner that the flow lines form next to the connecting ducts during injecting the plastic melt, and that during the subsequent pressure increase, plastic melt flows into the extra cavities, wherein a flow takes place through the flow line produced during the filling of the main cavity.

14. The method according to claim 4, characterized by the feature:
in the case of a plurality of injection points, the latter are actuated in such a manner that the flow lines form next to the connecting ducts during injecting the plastic melt, and that during the subsequent pressure increase, plastic melt flows into the extra cavities, wherein a flow takes place through the flow line produced during the filling of the main cavity.

15. The method according to claim 2, characterized by the feature:
the extra moldings formed in the extra cavity and the connecting duct are cut off.

16. The method according to claim 3, characterized by the feature:
the extra moldings formed in the extra cavity and the connecting duct are cut off.

17. The method according to claim 4, characterized by the feature:
the extra moldings formed in the extra cavity and the connecting duct are cut off.

18. The method according to claim 5, characterized by the feature:
the extra moldings formed in the extra cavity and the connecting duct are cut off.

19. A valve for pressurized fluids, in particular water, comprising a clamping ring made of plastic and producible according to a method according to claim 2, characterized in that the clamping ring comprises:
openings for fastening devices,
at least one injection point in the vicinity of one of the openings,
and at least one extra molding on that side of the opening that is facing away from the injection point.

20. A valve for pressurized fluids, in particular water, comprising a clamping ring made of plastic and producible according to a method according to claim 3, characterized in that the clamping ring comprises:
openings for fastening devices,
at least one injection point in the vicinity of one of the openings,
and at least one extra molding on that side of the opening that is facing away from the injection point.

21. A valve for pressurized fluids, in particular water, comprising a clamping ring made of plastic and producible according to a method according to claim 4, characterized in that the clamping ring comprises:
openings for fastening devices,
at least one injection point in the vicinity of one of the openings,
and at least one extra molding on that side of the opening that is facing away from the injection point.

22. A valve for pressurized fluids, in particular water, comprising a clamping ring made of plastic and producible according to a method according to claim 5, characterized in that the clamping ring comprises:
openings for fastening devices,
at least one injection point in the vicinity of one of the openings,
and at least one extra molding on that side of the opening that is facing away from the injection point.

23. A valve for pressurized fluids, in particular water, comprising a clamping ring made of plastic and producible according to a method according to claim 6, characterized in that the clamping ring comprises:
openings for fastening devices,
at least one injection point in the vicinity of one of the openings,
and at least one extra molding on that side of the opening that is facing away from the injection point.
